(19) United States
(12) Patent Application Publication
(10) Pub. No.: US 2026/0220859 A1
(43) Pub. Date: Jul. 30, 2026

(54) SYSTEMS AND METHODS FOR ENHANCING A VEHICLE OCCUPANT’S EXPERIENCE THROUGH DISPLAYED METAPHORICAL CONTENT

(71) Applicant: Toyota Jidosha Kabushiki Kaisha, Toyota-shi (JP)

(72) Inventor: Tyler C. La Monda, Fairfield, CA (US)

(73) Assignee: Toyota Jidosha Kabushiki Kaisha, Toyota-shi (JP)

(21) Appl. No.: 19/036,133

(22) Filed: Jan. 24, 2025

(51) Int. Cl. G06T 13/00; B60K 35/234; B60K 35/235; B60R 1/12

(52) U.S. Cl. CPC G06T 13/00; B60K 35/234; B60K 35/235; B60K 2360/31; B60R 1/12; B60R 2001/1253

(57) ABSTRACT

Systems and methods for enhancing a vehicle occupant’s experience through displayed metaphorical content are disclosed herein. One embodiment of a vehicle experience-enhancement system detects, through analysis of input data, a dynamic condition pertaining to a vehicle or the environment external to the vehicle. In response, the system displays, to an occupant of the vehicle, an animated metaphorical graphical representation of the status, in real time, of the dynamic condition to assist the occupant of the vehicle in engaging with the dynamic condition.

### TECHNICAL FIELD

The subject matter described herein generally relates to vehicles and, more particularly, to systems and methods for enhancing a vehicle occupant’s experience through displayed metaphorical content.

### BACKGROUND

Modern vehicles include electronic systems that present various kinds of content to vehicle occupants. Examples of such content include themed displays, multimedia content, menus for controlling vehicle settings and options, games, etc. However, such systems fall short in some important respects.

### SUMMARY

An example of a system for enhancing a vehicle occupant’s experience through displayed metaphorical content is presented herein. The system comprises a processor and a memory storing machine-readable instructions that, when executed by the processor, cause the processor to detect, through analysis of input data, a dynamic condition pertaining to a vehicle or the environment external to the vehicle. The memory also stores machine-readable instructions that, when executed by the processor, cause the processor to display, to an occupant of the vehicle, an animated metaphorical graphical representation of the status, in real time, of the dynamic condition to assist the occupant of the vehicle in engaging with the dynamic condition.

Another embodiment is a non-transitory computer-readable medium for enhancing a vehicle occupant’s experience through displayed metaphorical content and storing instructions that, when executed by a processor, cause the processor to detect, through analysis of input data, a dynamic condition pertaining to a vehicle or the environment external to the vehicle. The instructions also cause the processor to display, to an occupant of the vehicle, an animated metaphorical graphical representation of the status, in real time, of the dynamic condition to assist the occupant of the vehicle in engaging with the dynamic condition.

In another embodiment, a method of enhancing a vehicle occupant’s experience through displayed metaphorical content is disclosed. The method comprises detecting, through automated analysis of input data using a processor, a dynamic condition pertaining to a vehicle or the environment external to the vehicle. The method also includes displaying, to an occupant of the vehicle, an animated metaphorical graphical representation of the status, in real time, of the dynamic condition to assist the occupant of the vehicle in engaging with the dynamic condition.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a vehicle in which various embodiments of the systems and methods disclosed herein can be implemented.

FIG. 2 is a block diagram of a vehicle experience-enhancement system, in accordance with an illustrative embodiment of the invention.

FIG. 3A illustrates an example of an animated metaphorical graphical representation of a low-fuel condition in a vehicle, in accordance with an illustrative embodiment of the invention.

FIG. 3B illustrates another example of an animated metaphorical graphical representation of a low-fuel condition in a vehicle, in accordance with an illustrative embodiment of the invention.

FIG. 4 illustrates an example of an animated metaphorical graphical representation of traffic conditions and the presence of a speed trap, in accordance with an illustrative embodiment of the invention.

FIG. 5 illustrates an example of an animated metaphorical graphical representation of vehicle occupants’ progress in exploring a predetermined area, in accordance with an illustrative embodiment of the invention.

FIG. 6 illustrates an example of an animated metaphorical graphical representation of a vehicle traveling on hilly terrain, in accordance with an illustrative embodiment of the invention.

FIG. 7 illustrates an example of an animated metaphorical graphical representation of adverse road-surface conditions, in accordance with an illustrative embodiment of the invention.

FIG. 8 is a flowchart of a method of enhancing a vehicle occupant’s experience through displayed metaphorical content, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Various embodiments of systems and methods for enhancing a vehicle occupant’s experience through displayed metaphorical content are described herein. Herein, such a system is sometimes referred to by the shorter name “vehicle experience-enhancement system.” These various embodiments overcome some important shortcomings in conventional vehicular information systems. More specifically, conventional systems for presenting content to vehicle occupants lack awareness of dynamic conditions pertaining to (1) the vehicle itself and (2) the environment surrounding the vehicle, or they fail to incorporate awareness of such dynamic conditions in the content presented to vehicle occupants. Consequently, conventional systems fail to interact with vehicle occupants in accordance with real-time conditions pertaining to the vehicle and/or its surrounding environment.

The various embodiments described herein overcome these shortcomings by presenting content to vehicle occupants that provides the vehicle occupants with a rich, immersive, and situationally relevant experience while they are driving or riding in the vehicle. The various embodiments do so by detecting, through analysis of input data, a dynamic condition pertaining to a vehicle or the environment external to the vehicle. Herein, a “dynamic condition” is a condition that has at least the potential to change over time. As one example, a low-fuel condition is a condition (an operational state) pertaining to the vehicle itself. Further, it is a dynamic (changing) condition because it can worsen, if the driver fails to refuel the vehicle, or it can improve, if the driver refuels the vehicle. As a further example, a detected traffic jam in the vicinity of the vehicle is a dynamic condition pertaining to the external environment of the vehicle that can potentially change over time (i.e., it can worsen or improve). Once the various embodiments have detected a dynamic condition, the various embodiments display, to an occupant of the vehicle, an animated metaphorical graphical representation of the status, in real time, of the dynamic condition to assist the occupant of the vehicle in engaging with the dynamic condition.

The term “animated metaphorical graphical representation” will be explained in greater detail. Herein, “animated” refers to the displayed content being at least somewhat in motion (e.g., like a live-action or animated video), as opposed to a static image. “Metaphorical,” herein, means analogous, non-literal. For example, a video showing a flying saucer emerging from a crater in the ground could, in some embodiments, be a metaphorical representation for detected potholes in the roadway ahead. Rather than displaying to vehicle occupants text such as “Warning: Potholes ahead” or a literal image of a roadway with one or more potholes, the various embodiments described herein instead display a metaphorical representation such as the flying saucer and crater scenario just mentioned. Herein, “graphical representation” simply refers to the content displayed to vehicle occupants being computer-rendered. A “graphical representation” can include real-world images or video frames, synthetic images or video frames, or a combination thereof. In some embodiments, the displayed animated metaphorical graphical representation is created using a generative-artificial-intelligence-based model (e.g., a transformer neural network, diffusion model, etc.). Such generative-AI models can generate animated video content in response to one or more prompts (text, etc.). In the various embodiments described herein, the prompts can be generated by another aspect or component of the overall vehicle experience-enhancement system. For example, the portion of the overall system that detects a dynamic condition can, based on its understanding of the dynamic condition, generate suitable prompts for a generative-AI model. In other embodiments, the animated metaphorical graphical representation is retrieved from a memory containing prestored content.

One of the objectives of the various embodiments described herein is to assist a vehicle occupant (or multiple vehicle occupants) in engaging with a detected dynamic condition. To “engage” with a dynamic condition means to become aware of the dynamic condition and to pay attention to the dynamic condition as the state of the dynamic condition changes over time. Further, in some situations, “engaging” with the detected dynamic condition means responding appropriately to the dynamic condition. In some cases, the benefit to the vehicle occupant (e.g., the driver of the vehicle) of such engagement is that it enables the driver to control the vehicle in a safer or more effective manner. That is, such engagement can improve the manner in which the driver operates the vehicle. In other cases, such engagement increases the vehicle occupant’s perceived level of immersion or enjoyment while driving or riding in the vehicle.

One innovative aspect of the various embodiments herein is the use of animated metaphorical content to communicate concepts to vehicle occupants. Those skilled in the vehicular-information-systems art are aware of how difficult it is to get a vehicle occupant (e.g., a driver) to pay attention to warnings, alerts, and notifications on a vehicle instrument panel, infotainment display, or head-up display (HUD). An important advantage of an animated metaphorical graphical representation of a detected dynamic condition is that it requires the vehicle occupant to think at least momentarily about what the metaphorical content is intended to convey, which grabs the vehicle occupant’s attention and increases the vehicle occupant’s level of engagement with the detected dynamic condition. For example, a conventional vehicular information system might warn a driver that a pedestrian is in a crosswalk ahead by emitting a beeping sound and flashing a textual warning “Pedestrian ahead” or an icon of a walking person on a HUD. In contrast, in one embodiment of a vehicle experience-enhancement system, the system displays, on a partial or full-window HUD, an animated video sequence depicting a sloth slowly lumbering across the display. Such a metaphorical representation of the pedestrian ahead is likely to capture the attention of the driver. Moreover, since the driver is likely to find the slow-moving sloth to be amusing, the driver’s level of engagement with the detected dynamic condition (i.e., a pedestrian crossing the roadway in a crosswalk ahead) is increased. Also, when the driver first sees the displayed metaphor (the sloth), the driver is likely to look around and ahead in the external environment to see what the sloth might represent. In doing so, the driver spots the pedestrian in the crosswalk and understands the analogy. The result is that the driver pays more attention to the metaphorically conveyed information than to warnings or alerts conveyed in conventional ways, and, at the same time, the driver also enjoys the experience of driving more.

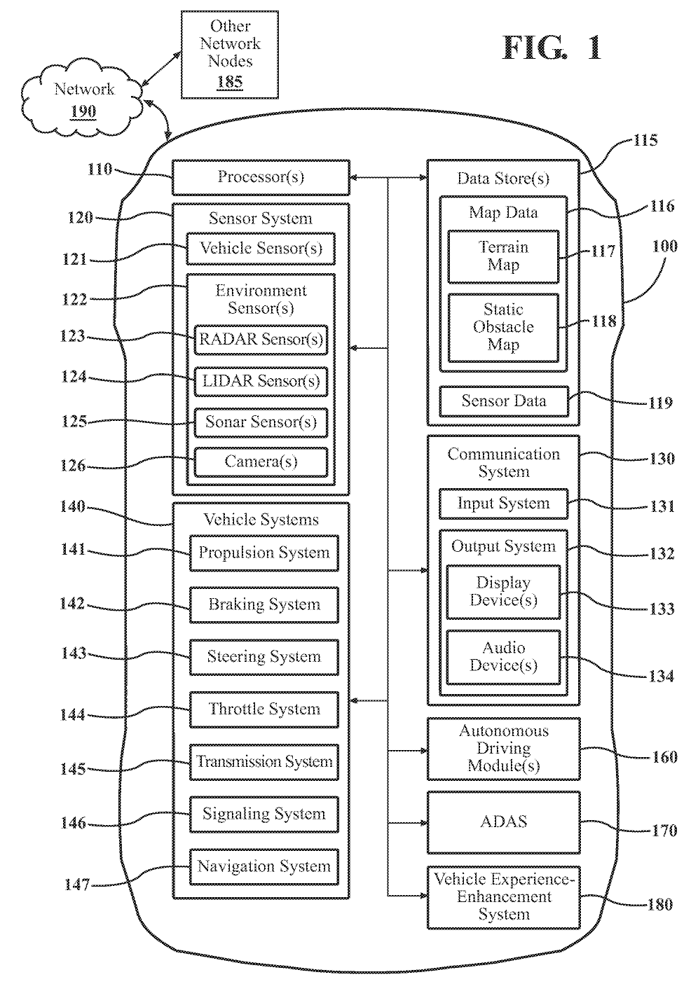

Referring to FIG. 1, it depicts a vehicle 100 in which various embodiments of methods and systems for enhancing a vehicle occupant’s experience through displayed metaphorical content can be implemented. As used herein, a “vehicle” is any form of motorized transport. One example of a “vehicle,” without limitation, is an automobile. As shown in FIG. 1, vehicle 100 can include a vehicle experience-enhancement system 180, which is described in detail below. Hereinafter, vehicle experience-enhancement system 180 (a system for enhancing a vehicle occupant’s experience through displayed metaphorical content) will often be referred to simply as the “system 180” for brevity.

In some embodiments, vehicle 100 includes an automated driving system that enables vehicle 100 to operate in a semi-automated or automated driving mode. For example, in some embodiments, vehicle 100 can operate at a high or total level of autonomy (e.g., Society of Automotive Engineers Autonomy Levels 3-5). As indicated in FIG. 1, vehicle 100 includes automated driving module(s) 160 that implement the automated driving system. In other embodiments, vehicle 100 can operate in a semi-automated driving mode by virtue of features such as adaptive cruise-control (ACC), automatic lane-change assistance, automatic lane-keeping assistance, and automatic parking assistance. In some embodiments, such features and others (e.g., automatic collision avoidance) are aspects of an Advanced Driver-Assistance System (ADAS) 170. In still other embodiments, vehicle 100 may be driven manually by a human driver.

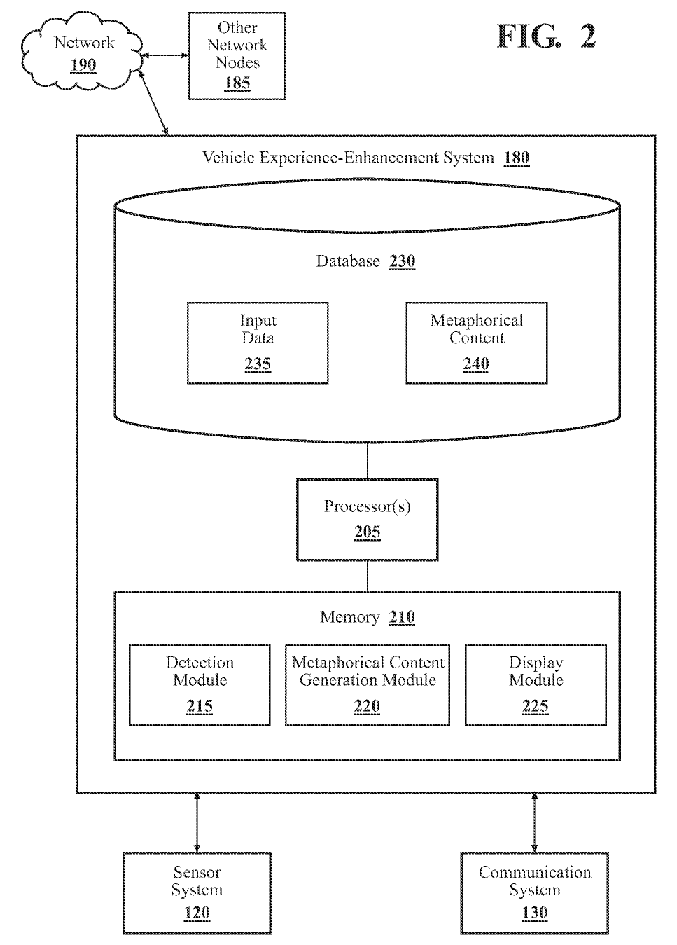

As indicated in FIG. 1, the vehicle 100 includes additional elements. It will be understood that, in various embodiments, it may not be necessary for the vehicle 100 to have all the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1, including vehicle experience-enhancement system 180. While the various elements are shown as being located within the vehicle 100 in FIG. 1, it will be understood that one or more of these elements can be located external to the vehicle 100. Further, the elements shown may be physically separated by large distances. Some of the possible elements of the vehicle 100 are shown in FIG. 1. However, a description of many of the elements in FIG. 1 will be provided after the discussion of FIGS. 2-8 for purposes of brevity of this description.

The sensor system 120 of vehicle 100 can include, among other things, one or more vehicle sensors 121. The vehicle sensors 121 can detect, determine, and/or sense information about the vehicle 100 itself, including the operational status of various vehicle components and systems (e.g., fuel level, battery charge, brakes, transmission, steering, etc.). This vehicle-status information can be conveyed to the system 180 via a controller area network (CAN) of the vehicle 100. Data from such vehicle sensors 121 is analyzed by the system 180 to detect dynamic conditions that pertain to operational states of the vehicle 100. The sensor system 120 can also include environment sensors 122, such as radar sensors 123, Light Detection and Ranging (LIDAR) sensors 124, sonar sensors 125, and cameras (interior and/or exterior) 126. Data from such environment sensors is analyzed by the system 180 to detect dynamic conditions (e.g., weather, traffic density, the presence of external road users, etc.) that pertain to the external environment of vehicle 100. Analysis of data from environment sensors 122 can include the use of algorithms such as object detection and recognition and trajectory prediction, which are components of what is sometimes referred to as “scene understanding” in the machine-vision art.

As shown in FIG. 1, vehicle 100 also includes a communication system 130. Communication 130 includes an input system 131 to accept input from one or more vehicle occupants, one or more display devices 133, and one or more audio devices 134. In displaying animated metaphorical graphical representations for detected dynamic conditions, the system 180 can employ one or more of a variety of display devices 133. Such display devices 133 can include, without limitation, one or more displays of an In-Vehicle Information System (IVIS) of vehicle 100, a tablet computer removably mounted to the back side of a seat of vehicle 100, a HUD in the vehicle 100 that is separate from the windows of the vehicle 100, a HUD that occupies at least a portion of a window (windshield, side window, or rear window) of the vehicle 100, a rearview mirror of the vehicle 100, and a side mirror of the vehicle.

As indicated in FIG. 1, vehicle 100 can communicate with other network nodes 185 (e.g., external Wi-Fi stations, other connected vehicles, cloud servers, edge servers, roadside units, infrastructure devices, etc.) via a network 190. In some embodiments, network 190 includes the Internet. In communicating with the other network nodes 180, vehicle 100 can employ wireless communication technologies such as IEEE 802.11 (Wi-Fi), C-V2X (e.g., 4G LTE-V2X or 5G NR V2X), cellular data, Bluetooth®, Bluetooth® Low Energy (LE), and Dedicated Short-Range Communications (DSRC).

FIG. 2 is a block diagram of a vehicle experience-enhancement system 180, in accordance with an illustrative embodiment of the invention. In FIG. 2, the system 180 includes one or more processors 205 to which a memory 210 is communicably coupled. The one or more processors 205 may be dedicated to the system 180, the system 180 may share one or more of the processors 110 of vehicle 100, or the system 180 may access the one or more processors 110 of vehicle 100 through a data bus or another communication path, depending on the embodiment. Memory 210 stores a detection module 215, a metaphorical content generation module 220, and a display module 225. The memory 210 is a random-access memory (RAM), read-only memory (ROM), a hard-disk drive, a flash memory, or other suitable non-transitory memory for storing the modules 215, 220, and 225. The modules 215, 220, and 225 are, for example, machine-readable instructions that, when executed by the one or more processors 205, cause the one or more processors 205 to perform the various functions disclosed herein.

As shown in FIG. 2, the system 180 interfaces with the various vehicle sensors 121 and environment sensors 122 of the sensor system 120 of vehicle 100, as discussed above. The system 180 also interfaces with the communication system 130 of vehicle 100, as discussed above.

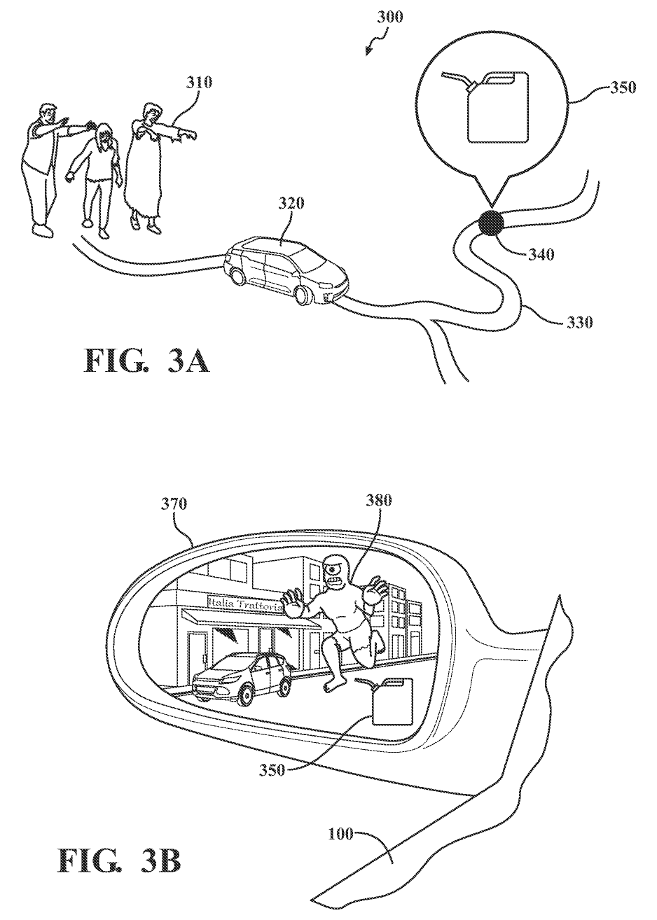

As also shown in FIG. 2, vehicle experience-enhancement system 180 can store various kinds of data in a database 230. For example, system 180 can store, in the database 230, input data 235 and metaphorical content 240. Input data 235 includes one or more of input from a vehicle occupant (e.g., spoken requests or input entered via the control elements of a user interface), vehicle sensor data from vehicle sensors 121, environment sensor data from environment sensors 122, data from a remote server (e.g., information regarding weather or traffic), physiological data (e.g., heartbeat, brainwave, respiration, etc., data) pertaining to a vehicle occupant, vehicle-occupant facial-expression data from interior camera(s) 126, vehicle-occupant gaze-tracking data from interior camera(s) 126, vehicle-occupant preferences data, and historical driving data pertaining to the vehicle 100. Metaphorical content 240 can include pre-generated and prestored metaphorical content that system 180 can retrieve and display in response to a detected dynamic condition. As mentioned above, in other embodiments system 180 creates the animated metaphorical graphical representations using a generative-AI model on an as-needed basis rather than pre-storing and retrieving the metaphorical content 240. A number of examples of dynamic conditions and animated metaphorical graphical representations are described below in connection with FIGS. 3A-7.

As discussed above in connection with FIG. 1, the system 180 communicates with other network nodes 185 (e.g., external Wi-Fi stations, other connected vehicles, cloud servers, edge servers, roadside units, infrastructure devices, etc.) via a network 190. In some embodiments, network 190 includes the Internet. In communicating with the other network nodes 185, system 180 can employ wireless communication technologies such as IEEE 802.11 (Wi-Fi), C-V2X (e.g., 4G LTE-V2X or 5G NR V2X), cellular data, Bluetooth®, Bluetooth® Low Energy (LE), and Dedicated Short-Range Communications (DSRC).

Detection module 215 generally includes machine-readable instructions that, when executed by the one or more processors 205, cause the one or more processors 205 to detect, through analysis of input data 235, a dynamic condition pertaining to a vehicle 100 or the environment external to the vehicle 100. Detection module 215 detects dynamic conditions by analyzing any of a wide variety of input data 235 discussed above. For example, such analysis can include, without limitation, analyzing one or more of the following: (1) input from a vehicle occupant (e.g., a spoken request, gesture, or action via user interface); (2) the states of various vehicle sensors 121 (e.g., fuel/charge level, speed, steering angle, coolant level, transmission status, braking system status, etc.); (3) data from environment sensors 122 (e.g., to detect and recognize objects in the environment such as other road users); (4) data from a remote server (e.g., weather or traffic information); (5) physiological data pertaining to a vehicle occupant; (6) vehicle-occupant facial-expression data (e.g., from an interior camera 126); (7) vehicle-occupant gaze-tracking data; (8) vehicle-occupant preferences data; and (9) historical driving data pertaining to the vehicle 100.

A number of specific examples of dynamic conditions and possible animated metaphorical graphical representations that the system 180 might display in response to those dynamic conditions are discussed below. Some of those examples are illustrated in FIGS. 3A-7. There are many possible dynamic conditions (too many to name and describe in this Detailed Description), but the following categories, without limitation, encompass some of the possibilities: (1) dynamic conditions that pertain to an operational state of the vehicle (e.g., fuel/charge level, tire pressure, coolant level, etc.); (2) dynamic conditions that pertain to traffic (e.g., density, traffic jams, etc.), terrain, weather, or time of day; (3) dynamic conditions that pertain to the roadway on which the vehicle 100 is traveling (e.g., the presence of potholes, construction zones, road closures, etc.); and (4) dynamic conditions that pertain to an external road user (e.g., another vehicle, a pedestrian, a bicyclist, etc.).

Metaphorical content generation module 220 generally includes machine-readable instructions that, when executed by the one or more processors 205, cause the one or more processors 205, in response to the dynamic condition detected by detection module 215, to retrieve prestored (predetermined) metaphorical content 240 or to generate metaphorical content 240 using a generative-AI model such as a transformer neural network or a diffusion model.

Metaphorical content generation module 220 retrieves or generates metaphorical content 240 that is suggestive of or analogous to the dynamic condition detected by detection module 215. For example, in an embodiment in which the metaphorical content 240 is created and stored beforehand, metaphorical content generation module 220 can consult a lookup table that maps various kinds of dynamic conditions to representative metaphorical content 240. Where multiple kinds of metaphorical content 240 map to the same dynamic condition, metaphorical content generation module 220 can select a specific kind of metaphorical content 240 that best fits the circumstances, or a particular kind of metaphorical content 240 can be selected randomly. Where metaphorical content generation module 220 employs generative AI, suitable automatically generated prompts based on the dynamic condition detected by detection module 215 can be used to generate, in real time, tailored metaphorical content 240.

Display module 225 generally includes machine-readable instructions that, when executed by the one or more processors 205, cause the one or more processors 205 to display, to an occupant (or to multiple occupants) of the vehicle 100, an animated metaphorical graphical representation of the status, in real time, of the detected dynamic condition to assist the occupant of the vehicle 100 in engaging with the dynamic condition. As discussed above, display module 225 can display the animated metaphorical graphical representation on at least one of the following: (1) one or more displays of an IVIS of vehicle 100; (2) a tablet computer removably mounted to the back side of a seat of vehicle 100; (3) a HUD in the vehicle 100 that is separate from the windows of the vehicle 100; (4) a HUD that occupies at least a portion of a window (windshield, side window, or rear window) of the vehicle 100; (5) a rearview mirror of the vehicle 100; and (6) a side mirror of the vehicle 100.

Several examples of specific use cases for the vehicle experience-enhancement system 180 discussed above in connection with FIGS. 1 and 2 are presented below in connection with FIGS. 3A-7. Additional use cases are also described following the discussion of FIG. 7.

FIG. 3A illustrates an example of an animated metaphorical graphical representation 300 of a low-fuel condition in a vehicle 100, in accordance with an illustrative embodiment of the invention. In the example of FIG. 3A, detection module 215 has detected, via one or more vehicle sensors 121, a dynamic condition pertaining to the vehicle 100, namely that vehicle 100 is low on fuel (in this example, the vehicle is an internal-combustion-engine vehicle that burns gasoline, but in other embodiments, the dynamic condition could pertain to the battery charge level of an electric vehicle).

Metaphorical content generation module 220 retrieves or generates the animated metaphorical graphical representation 300 (an example of metaphorical content 240), and display module 225 displays the animated metaphorical graphical representation 300 to one or more vehicle occupants. In this example, the animated metaphorical graphical representation 300 depicts a local map on which a vehicle graphic 320 representing the vehicle 100 is traveling. A dot on the map represents a nearby refueling station 340, and a gas can icon 350 provides context to assist the vehicle occupant (e.g., the driver) in interpreting the metaphorical content 240. In this example, the low-fuel condition is represented metaphorically by a “zombie horde” 310 slowly pursuing the vehicle graphic 320. The lower the fuel level in vehicle 100 becomes, the closer the zombie horde gets to the vehicle graphic 320 representing the vehicle 100. If the vehicle 100 runs out of gas, the zombie horde “catches” the vehicle graphic 320 representing the vehicle 100. This is an interesting, engaging way to communicate to the vehicle occupant (e.g., the driver) that vehicle 100 is low on fuel (or electrical charge). Note that, under this particular dynamic condition, the situation can become progressively worse, if the vehicle occupant takes no action to refuel the vehicle 100. The animated metaphorical graphical representation 300 represents that change (worsening) over time through the relentless approach, to the vehicle graphic 320, of the zombie horde 310.

FIG. 3B illustrates another example of an animated metaphorical graphical representation of a low-fuel condition in a vehicle, in accordance with an illustrative embodiment of the invention. In this example, the detected dynamic condition (low fuel) is the same as in FIG. 3A, but the metaphorical content 240 representing and tracking that dynamic condition is different. In the example of FIG. 3B, display module 225 displays, in a side mirror 370 of the vehicle 100, an animated metaphorical graphical representation that includes a menacing virtual FIG. 380 “pursuing” vehicle 100 from behind and a hovering gas can icon 350 for context. The lower the fuel level in vehicle 100 becomes, the closer the menacing virtual FIG. 380 appears to be (i.e., the menacing virtual FIG. 380 grows larger in the side mirror 370). Such an animated metaphorical graphical representation of the low-fuel condition is likely to grab a vehicle occupant’s attention and to be experienced as amusing, engaging the vehicle occupant’s attention and assisting the vehicle occupant in taking the low-fuel condition seriously by promptly stopping at a refueling station.

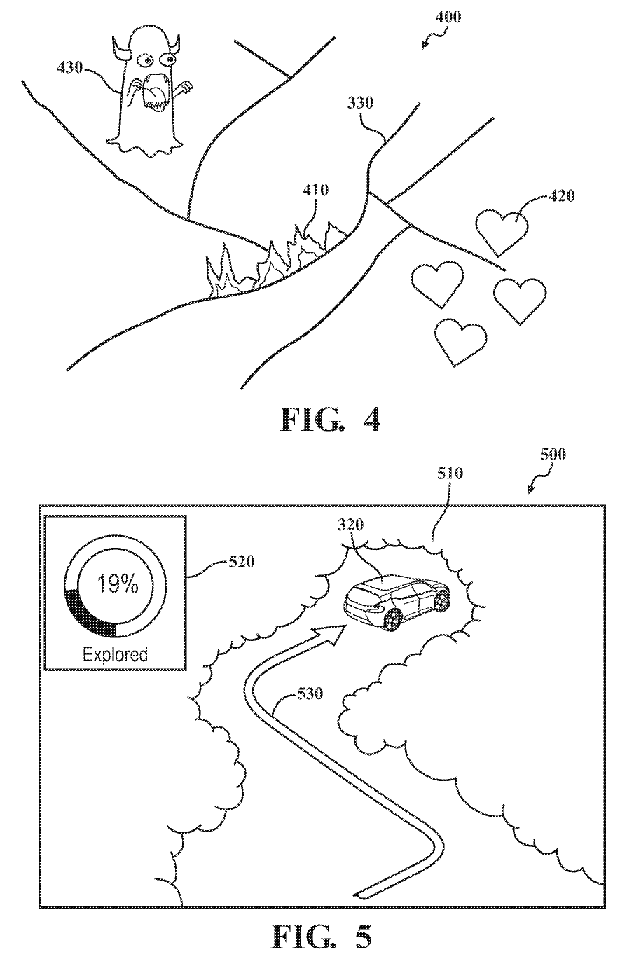

FIG. 4 illustrates an example of an animated metaphorical graphical representation 400 of traffic conditions and the presence of a speed trap, in accordance with an illustrative embodiment of the invention. In this example, detection module 215 detects a plurality of dynamic conditions: (1) the presence of a traffic jam along a particular stretch of nearby roadway, (2) favorable traffic conditions along a different stretch of nearby roadway, and (3) the presence of a police vehicle (a likely speed trap) on the side of another nearby street. All three of these detected conditions are “dynamic” because they can potentially change over time. The traffic jam can improve or worsen further, the roadway segment without traffic congestion can become congested, and the police officer(s) in the detected police vehicle can drive elsewhere.

In this example, metaphorical content generation module 220 retrieves or generates metaphorical content 240 that includes animated fire 410 to represent the traffic jam, hearts 420 to represent the favorable (uncongested) roadway segment, and a monster 430 to represent the potential speed trap. These metaphorical elements are combined with a simple map of the network of nearby roadways, the map providing context for the metaphorical elements. Display module 225 displays the animated metaphorical graphical representation 400 on one or more display devices 133 in vehicle 100. In this case, if the traffic jam clears, the intensity of the animated fire 410 can be reduced or even changed to some wisps of smoke that eventually fade away. If the police vehicle leaves its initial location, the monster 430 can be shown to run away beyond the boundaries of the display device 133.

FIG. 5 illustrates an example of an animated metaphorical graphical representation 500 of vehicle occupants’ progress in exploring a predetermined area, in accordance with an illustrative embodiment of the invention. In this example, detection module 215 detects the dynamic condition that one or more occupants of a vehicle 100 are exploring an unfamiliar geographical area that is of interest to the occupants. For example, detection module 215 might detect and analyze spoken conversation to that effect among vehicle occupants.

In response, metaphorical content generation module 220 retrieves or generates an animated metaphorical graphical representation 500 in which a vehicle graphic 320 representing vehicle 100 is shown driving around in a thick mist or fog 510. In this animated metaphorical graphical representation 500, wherever vehicle 100 (represented by vehicle graphic 320) has traveled (the trajectory traced by the arrow graphic 530), the fog 510 is shown as having dissipated. Wherever vehicle 100 has not yet traveled is represented by the remaining thick fog 510. The animated metaphorical graphical representation 500 also includes a progress indicator 520 that informs the vehicle occupants how much, as a percentage, of the area of interest has been explored thus far. Display module 225 displays the animated metaphorical graphical representation 500 on one or more display devices 133 in vehicle 100. This example illustrates that the detected dynamic condition is not limited to safety- or vehicle-operational-status-related conditions. In this case, the objective of the system 180 in displaying the animated metaphorical graphical representation 500 is to assist the vehicle occupants in engaging with and enjoying their present experience of exploring a new area or region. That is, the system 180 assists the vehicle occupants in engaging with the dynamic condition—exploring their environment.

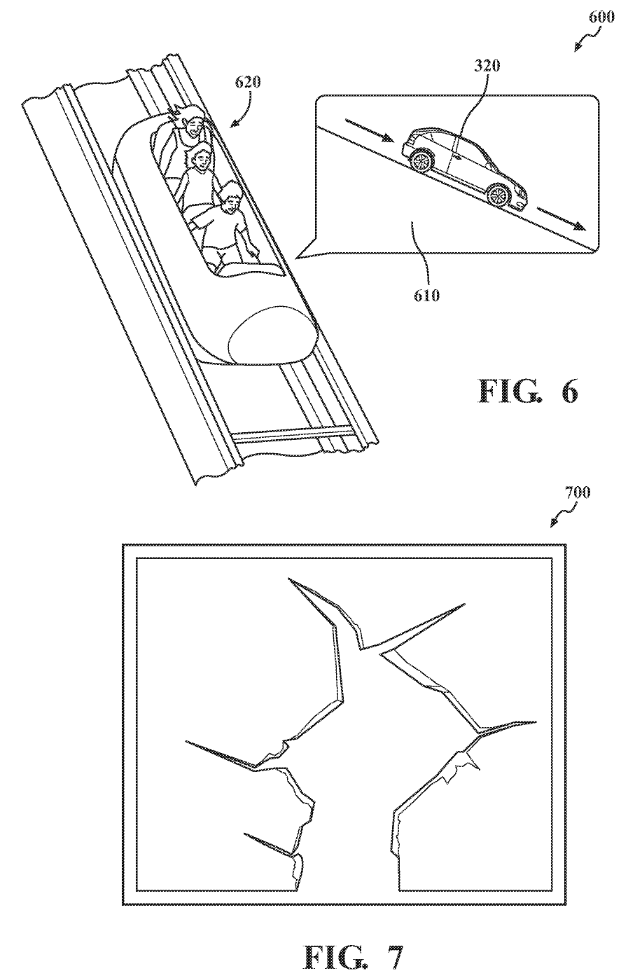

FIG. 6 illustrates an example of an animated metaphorical graphical representation 600 of a vehicle traveling on hilly terrain, in accordance with an illustrative embodiment of the invention. In this example, detection module 215 detects (e.g., through accelerometers or a gyroscope) the dynamic condition that vehicle 100 is traveling on hilly terrain. In response, metaphorical content generation module 220 retrieves or generates the animated metaphorical graphical representation 600, which includes a vehicle graphic 320 representing the vehicle 100 traveling on a steep downward grade 610 for context combined with a metaphorical representation of an amusement-park water ride 620 that is analogous to the detected dynamic condition. Display module 225 displays the animated metaphorical graphical representation 600 on one or more display devices 133 in vehicle 100. Such metaphorical content 240 is likely to be found amusing by one or more vehicle occupants, increasing their enjoyment of and engagement with the present circumstances—the hilly terrain. Children, in particular, enjoy present circumstances being analogized to a metaphorical representation that is fun or adventurous.

FIG. 7 illustrates an example of an animated metaphorical graphical representation of adverse road-surface conditions, in accordance with an illustrative embodiment of the invention. In this example, detection module 215 detects (e.g., from analysis of data from environment sensors 122 or based on information from a remote server) that the roadway surface ahead is in bad shape (lots of cracks, potholes, etc.). In response, metaphorical content generation module 220 retrieves or generates the animated metaphorical graphical representation 700, a wall of stone or other material with a gaping hole, cracks, etc. The animation can include pieces of the wall falling down, the cracks enlarging, etc. This is a metaphorical notification to the occupants of vehicle 100 that the condition of the roadway ahead is poor. Display module 225 displays the animated metaphorical graphical representation 700 on one or more display devices 133 in vehicle 100.

A variety of additional illustrative, non-limiting use cases for the vehicle experience-enhancement system 180 are summarized below. In these brief examples, it is understood that metaphorical content generation module 220 either retrieves or generates the described animated metaphorical graphical representation of a detected dynamic condition that display module 225 ultimately displays to one or more vehicle occupants in a vehicle 100.

Weather Changes: Detection module 215 detects the beginning of a rainstorm, and display module 225 displays drops of water and/or a metaphorical fish tank filling with water as rain continues to fall.

Proximity to Wildlife Areas: Detection module 215 detects that vehicle 100 is nearing an area where frequent animal crossings occur. Display module 225 displays animated animal footprints or plays animal sounds over an audio device 134 as gentle hints of the need to exercise caution.

Ambient Noise Levels: Detection module 215 monitors the noise level in different parts of a city as vehicle 100 drives around. Display module 225 displays the rising and falling noise levels outside the vehicle as rising or falling sound waves or as a tuning fork vibrating with varying intensity.

Speed Limit Changes: Detection module 215 monitors speed limits as the vehicle 100 drives around in a particular area (e.g., a city). Display module 225 metaphorically represents the changing speed limits as a color or color pattern (e.g., slower speed limits might be represented as a calming color gradient, and higher speed limits might be represented as sharper, more vivid colors).

Construction Zones: Detection module 215 detects a construction zone ahead (the dynamic condition). Display module 225 displays building blocks or rough textures to suggest the presence of a construction zone nearby, highlighting the need to stay alert.

School Zones or Pedestrian Areas: Detection module 215 detects a school zone or pedestrian area ahead. Display module 225 displays a calming, playful animation of children’s toys or penguins sauntering along an icy coastline to subtly remind the driver of vehicle 100 to slow down and remain cautious.

Seasonal Changes: Detection module 215 detects the time of year (the season). Display module 225 displays leaves; flying kites; a sun with a happy, smiling face; or snowflakes to align the displayed metaphorical content 240 with the natural surroundings at the applicable time of year.

Speed Bumps Ahead: Detection module 215 detects one or more speed bumps ahead. Display module 225 displays tiny hills or mounds with cartoon hedgehogs climbing over them, providing an amusing “heads up” regarding the upcoming bumps.

Sharp Curves: Detection module 215 detects (e.g., based on environment-sensor data or map data) that the roadway ahead includes one or more sharp curves. Display module 225 displays a curvy roller-coaster track (or an animation of a roller-coaster car traveling over a curvy roller-coaster track) to warn the driver of vehicle 100 and to assist the driver in remaining engaged and alert.

Bicyclists Nearby: Detection module 215 detects one or more bicyclists on the roadway near vehicle 100. Display module 225 displays animated friendly cats on scooters or skateboards to remind the driver of vehicle 100 to share the road.

Emergency Vehicle Nearby: Detection module 215 detects an emergency vehicle (e.g., a firetruck or ambulance) nearby. Display module 225 displays a flashing superhero symbol (e.g., a Batman symbol), reminding the driver of vehicle 100 that the first responders are the heroes who are trying to help in difficult situations and encouraging the driver to be a “hero” too by making way for the emergency vehicle(s).

Heavy Traffic or Gridlock: Detection module 215 detects dense traffic (a “traffic jam”) or gridlock situation. Display module 225 displays a line of snails crawling at a leisurely pace to indicate, metaphorically, that traffic is moving slowly.

High-Speed Roadways: Detection module 215 detects that the vehicle 100 is entering a high-speed roadway (e.g., the Autobahn in Germany). Display module 225 displays a metaphorical rocket or racecar animation that zooms across the display, energizing the driver of vehicle 100 for a faster journey.

Sunrise or Sunset: Detection module 215 detects that it is sunrise or sunset. Display module 225 displays a whimsical rooster crowing for sunrise or an owl snoozing for sunset, providing a charming indication to vehicle occupants of the current time of day.

Vehicle Occupant’s Completion of Planned Tasks: Detection module 215 detects that an occupant of vehicle 100 (e.g., the driver) has completed several planned tasks such as “pick up children from school,” “grocery shop,” “drop off suit at the drycleaners,” etc. Such information might be obtained, for example, from the calendar app on the driver’s Bluetooth®-connected smartphone. Display module 225 displays a tipping balance scale or filling-cup metaphor to represent the driver’s completed tasks as the day progresses. Seeing the completed tasks represented metaphorically in this way can help the driver to feel a greater sense of accomplishment and satisfaction that the day has been productive.

In some embodiments, vehicle experience-enhancement system 180 is implemented in part at a cloud server to reduce the computational load at the vehicle 100. In other embodiments, vehicle experience-enhancement system 180 is entirely self-contained within the vehicle 100.

In some embodiments, vehicle experience-enhancement system 180 accepts requests for particular themes or metaphorical content 240 from vehicle occupants. For example, a vehicle occupant might utter a spoken request that the vehicle experience-enhancement system 180 display an animated metaphorical graphical representation of a particular kind when the vehicle 100 is stuck behind slow traffic. For example, the driver of vehicle 100 might say something like, “When I’m stuck behind a slow car or truck like this, show me an animation of a turtle struggling along a trail. I like that better than a mule.”

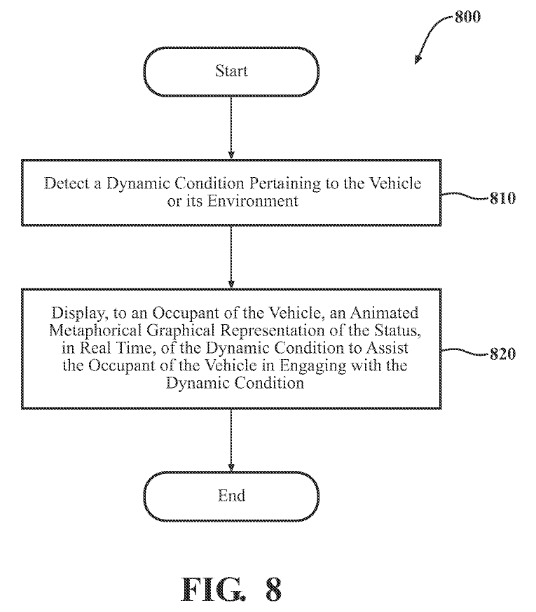

FIG. 8 is a flowchart of a method 800 of enhancing a vehicle occupant’s experience through displayed metaphorical content, in accordance with an illustrative embodiment of the invention. Method 800 will be discussed from the perspective of the vehicle experience-enhancement system 180 in FIG. 2. While method 800 is discussed in combination with vehicle experience-enhancement system 180, it should be appreciated that method 800 is not limited to being implemented within the system 180, but the system 180 is instead one example of a system that may implement method 800.

At block 810, detection module 215 detects, through analysis of input data 235, a dynamic condition pertaining to one of a vehicle 100 and an environment external to the vehicle 100. Numerous examples of dynamic conditions are discussed above. As also discussed above, detection module 215 detects dynamic conditions by analyzing any of a wide variety of input data 235. For example, such analysis can include analyzing one or more of the following: (1) input from a vehicle occupant (e.g., a spoken request, gesture, or action via user interface); (2) the states of various vehicle sensors 121 (e.g., fuel/charge level, speed, steering angle, coolant level, transmission status, braking system status, etc.); (3) data from environment sensors 122 (e.g., to detect and recognize objects in the environment such as other road users); (4) data from a remote server (e.g., weather or traffic information); (5) physiological data pertaining to a vehicle occupant; (6) vehicle-occupant facial-expression data (e.g., from an interior camera 126); (7) vehicle-occupant gaze-tracking data; (8) vehicle-occupant preferences data; and (9) historical driving data pertaining to the vehicle 100.

In response to the dynamic condition detected by detection module 215, metaphorical content generation module 220 either retrieves or generates an animated metaphorical graphical representation that relates to the dynamic condition, as discussed above. Metaphorical content generation module 220 retrieves or generates metaphorical content 240 that is suggestive of or analogous to the dynamic condition detected by detection module 215. For example, in an embodiment in which the metaphorical content 240 is created and stored beforehand, metaphorical content generation module 220 can consult a lookup table that maps various kinds of dynamic conditions to representative metaphorical content 240. Where multiple kinds of metaphorical content 240 map to the same dynamic condition, metaphorical content generation module 220 can select a specific kind of metaphorical content 240 that best fits the circumstances, or a particular kind of metaphorical content 240 can be selected randomly. Where metaphorical content generation module 220 employs generative AI, suitable automatically generated prompts based on the dynamic condition detected by detection module 215 can be used to generate, in real time, tailored metaphorical content 240.

At block 820, display module 225 displays, to an occupant of the vehicle 100, an animated metaphorical graphical representation of the status, in real time, of the dynamic condition to assist the occupant of the vehicle 100 in engaging with the dynamic condition. As explained above, one of the objectives of the various embodiments described herein is to assist a vehicle occupant (or multiple vehicle occupants) in engaging with a detected dynamic condition. To “engage” with a dynamic condition means to become aware of the dynamic condition and to pay attention to the dynamic condition as the state of the dynamic condition changes over time. Further, in some situations, “engaging” with the detected dynamic condition means responding appropriately to the dynamic condition. In some cases, the benefit to the vehicle occupant (e.g., the driver of the vehicle 100) of such engagement is that it enables the driver to control the vehicle 100 in a safer or more effective manner. That is, such engagement can improve the manner in which the driver operates the vehicle 100. In other cases, such engagement increases the vehicle occupant’s perceived level of immersion or enjoyment while driving or riding in the vehicle 100.

As also explained above, one innovative aspect of the various embodiments herein is the use of animated metaphorical content 240 to communicate with vehicle occupants. Those skilled in the vehicular-information-systems art are aware of how difficult it is to get a vehicle occupant (e.g., a driver) to pay attention to warnings, alerts, and notifications on a vehicle instrument panel, infotainment display, or head-up display (HUD). An important advantage of an animated metaphorical graphical representation of a detected dynamic condition is that it requires the vehicle occupant to think at least momentarily about what the metaphorical content is intended to convey, which grabs the vehicle occupant’s attention and increases the vehicle occupant’s level of engagement with the detected dynamic condition. For example, a conventional vehicular information system might warn a driver that a pedestrian is in a crosswalk ahead by emitting a beeping sound and flashing a textual warning “Pedestrian ahead” or an icon of a walking person on a HUD. In contrast, in one embodiment of a vehicle experience-enhancement system, the system displays, on a partial or full-window HUD, an animated video sequence depicting a sloth slowly lumbering across the display. Such a metaphorical representation of the pedestrian ahead is likely to capture the attention of the driver. Moreover, since the driver is likely to find the slow-moving sloth to be amusing, the driver’s level of engagement with the detected dynamic condition (i.e., a pedestrian crossing the roadway in a crosswalk ahead) is increased. Also, when the driver first sees the displayed metaphor (the sloth), the driver is likely to look around and ahead in the external environment to see what the sloth might represent. In doing so, the driver spots the pedestrian in the crosswalk and understands the analogy. The result is that the driver pays more attention to the metaphorically conveyed information than to warnings or alerts conveyed in conventional ways, and, at the same time, the driver also enjoys the experience more, perhaps even getting a chuckle out of it.

FIG. 1 will now be discussed in full detail as an example vehicle environment within which the systems and methods disclosed herein may be implemented. In some instances, the vehicle 100 can be configured to switch selectively between an automated mode, one or more semi-automated operational modes, and/or a manual mode. Such switching, also referred to as handover when transitioning to a manual mode, can be implemented in a suitable manner, now known or later developed. “Manual mode” means that all of or a majority of the navigation and/or maneuvering of the vehicle is performed according to inputs received from a user (e.g., human driver/operator).

In one or more implementations, the vehicle 100 can be an automated vehicle. As used herein, “automated vehicle” refers to a vehicle that operates in an automated mode. “Automated mode” refers to navigating and/or maneuvering a vehicle along a travel route using one or more computing devices to control the vehicle with minimal or no input from a human driver/operator. In one implementation, the vehicle 100 is configured with one or more semi-automated operational modes in which one or more computing devices perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route. Thus, in one or more implementations, the vehicle 100 operates autonomously according to a particular defined level of autonomy.

The vehicle 100 can include one or more processors 110. In one or more arrangements, the one or more processors 110 can be a main processor of the vehicle 100. For instance, the one or more processors 110 can be an electronic control unit (ECU). The vehicle 100 can include one or more data stores 115 for storing one or more types of data. The data store(s) 115 can include volatile and/or non-volatile memory. Examples of suitable data stores 115 include RAM, flash memory, ROM, PROM (Programmable Read-Only Memory), EPROM, EEPROM (Electrically Erasable Programmable Read-Only Memory), registers, magnetic disks, optical disks, hard drives, or any other suitable storage medium, or any combination thereof. The data store(s) 115 can be a component(s) of the one or more processors 110, or the data store(s) 115 can be operatively connected to the one or more processors 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangement, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangement, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can function independently from each other. Alternatively, two or more of the sensors can work in combination with each other. In such a case, the two or more sensors can form a sensor network. The sensor system 120 and/or the one or more sensors can be operatively connected to the one or more processors 110, the data store(s) 115, and/or another element of the vehicle 100 (including any of the elements shown in FIG. 1).

The sensor system 120 can include any suitable type of sensor. Various examples of different types of sensors will be described herein. However, it will be understood that the implementations are not limited to the particular sensors described. The sensor system 120 can include one or more vehicle sensors 121. The vehicle sensors 121 can detect, determine, and/or sense information about the vehicle 100 itself, including the operational status of various vehicle components and systems.

In one or more arrangements, the vehicle sensors 121 can be configured to detect, and/or sense position and/orientation changes of the vehicle 100, such as, for example, based on inertial acceleration. In one or more arrangements, the vehicle sensors 121 can include one or more accelerometers, one or more gyroscopes, an inertial measurement unit (IMU), a dead-reckoning system, a global navigation satellite system (GNSS), a global positioning system (GPS), a navigation system 147, and /or other suitable sensors. The vehicle sensors 121 can be configured to detect, and/or sense one or more characteristics of the vehicle 100. In one or more arrangements, the vehicle sensors 121 can include a speedometer to determine a current speed of the vehicle 100.

Alternatively, or in addition, the sensor system 120 can include one or more environment sensors 122 configured to acquire, and/or sense driving environment data. “Driving environment data” includes any data or information about the external environment in which a vehicle is located or one or more portions thereof. For example, the one or more environment sensors 122 can be configured to detect, quantify, and/or sense obstacles in at least a portion of the external environment of the vehicle 100 and/or information/data about such obstacles. The one or more environment sensors 122 can be configured to detect, measure, quantify, and/or sense other things in at least a portion the external environment of the vehicle 100, such as, for example, nearby vehicles, lane markers, signs, traffic lights, traffic signs, lane lines, crosswalks, curbs proximate the vehicle 100, off-road objects, etc.

Various examples of sensors of the sensor system 120 are discussed above. The example sensors may be part of the one or more environment sensors 122 and/or the one or more vehicle sensors 121. Moreover, the sensor system 120 can include operator sensors that function to track or otherwise monitor aspects related to the driver/operator of the vehicle 100. However, it will be understood that the implementations are not limited to the particular sensors described. As an example, in one or more arrangements, the sensor system 120 can include one or more radar sensors 123, one or more LIDAR sensors 124, one or more sonar sensors 125, and/or one or more cameras 126.

The vehicle 100 can further include a communication system 130. The communication system 130 can include one or more components configured to facilitate communication between the vehicle 100 and one or more communication sources. Communication sources, as used herein, refers to people or devices with which the vehicle 100 can communicate with, such as external networks, computing devices, operator or occupants of the vehicle 100, or others. As part of the communication system 130, the vehicle 100 can include an input system 131. An “input system” includes any device, component, system, element or arrangement or groups thereof that enable information/data to be entered into a machine. In one or more examples, the input system 131 can receive an input from a vehicle occupant (e.g., a driver or a passenger). The vehicle 100 can include an output system 132. An “output system” includes any device, component, or arrangement or groups thereof that enable information/data to be presented to the one or more communication sources (e.g., a person, a vehicle passenger, etc.). The communication system 130 can further include specific elements which are part of or can interact with the input system 131 or the output system 132, such as one or more display device(s) 133, and one or more audio device(s) 134 (e.g., speakers and microphones).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or combinations thereof, now known or later developed.

The one or more processors 110 and/or the automated driving module(s) 160 can be operatively connected to communicate with the various vehicle systems 140 and/or individual components thereof. For example, returning to FIG. 1, the one or more processors 110 and/or the automated driving module(s) 160 can be in communication to send and/or receive information from the various vehicle systems 140 to control the movement, speed, maneuvering, heading, direction, etc. of the vehicle 100. The one or more processors 110 and/or the automated driving module(s) 160 may control some or all of these vehicle systems 140 and, thus, may be partially or fully automated.

The vehicle 100 can include one or more modules, at least some of which are described herein. The modules can be implemented as computer-readable program code that, when executed by a processor 110, implement one or more of the various processes described herein. The processor 110 can be a device, such as a CPU, which is capable of receiving and executing one or more threads of instructions for the purpose of performing a task. One or more of the modules can be a component of the one or more processors 110, or one or more of the modules can be executed on and/or distributed among other processing systems to which the one or more processors 110 is operatively connected. The modules can include instructions (e.g., program logic) executable by one or more processors 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

In some implementations, the vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine the position and velocity of the vehicle 100. The automated driving module(s) 160 can determine the location of obstacles, or other environmental features including traffic signs, trees, shrubs, neighboring vehicles, pedestrians, etc.

The automated driving module(s) 160 can be configured to determine travel path(s), current automated driving maneuvers for the vehicle 100, future automated driving maneuvers and/or modifications to current automated driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140). The noted functions and methods will become more apparent with a further discussion of the figures.

Detailed implementations are disclosed herein. However, it is to be understood that the disclosed implementations are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various implementations are shown in FIGS. 1-8, but the implementations are not limited to the illustrated structure or application.

The flowcharts and block diagrams in the figures illustrate the architecture, functionality, and operation of possible implementations of systems, methods, and computer program products according to various implementations. In this regard, each block in the flowcharts or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can be executed substantially concurrently, or the blocks can sometimes be executed in the reverse order, depending upon the functionality involved.

The systems, components and/or methods described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or methods also can be embedded in a computer-readable storage, such as a computer program product or other data programs storage device, readable by a machine, tangibly embodying a program of instructions executable by the machine to perform methods and methods described herein. These elements also can be embedded in an application product which comprises all the features enabling the implementation of the methods described herein and, which when loaded in a processing system, is able to carry out these methods.

Furthermore, arrangements described herein can take the form of a computer program product embodied in one or more computer-readable media having computer-readable program code embodied or embedded, such as stored thereon. Any combination of one or more computer-readable media can be utilized. The computer-readable medium can be a computer-readable signal medium or a computer-readable storage medium. The phrase “computer-readable storage medium” means a non-transitory storage medium. A computer-readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a RAM, a ROM, an EPROM or Flash memory, an optical fiber, a portable compact disc read-only memory (CD-ROM), a digital versatile disc (DVD), an optical storage device, a magnetic storage device, or any suitable combination of the foregoing. In the context of this document, a computer-readable storage medium can be any tangible medium that can contain, or store a program for use by, or in connection with, an instruction execution system, apparatus, or device.

Program code embodied on a computer-readable medium can be transmitted using any appropriate medium, including but not limited to wireless, wireline, optical fiber, cable, RF, etc., or any suitable combination of the foregoing. Computer program code for carrying out operations for aspects of the present arrangements can be written in any combination of one or more programming languages, including an object-oriented programming language such as Java™, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a LAN or a WAN, or the connection can be made to an external computer (for example, through the Internet using an Internet Service Provider).

In the description above, certain specific details are outlined in order to provide a thorough understanding of various implementations. However, one skilled in the art will understand that the invention may be practiced without these details. In other instances, well-known structures have not been shown or described in detail to avoid unnecessarily obscuring descriptions of the implementations. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one or more implementations” or “an implementation” means that a particular feature, structure or characteristic described in connection with the implementation is included in at least one or more implementations. Thus, the appearances of the phrases “in one or more implementations” or “in an implementation” in various places throughout this specification are not necessarily all referring to the same implementation. Furthermore, the particular features, structures, or characteristics may be combined in any suitable manner in one or more implementations. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings (such as “Background” and “Summary”) and sub-headings used herein are intended only for general organization of topics within the present disclosure and are not intended to limit the disclosure of the technology or any aspect thereof. The recitation of multiple implementations having stated features is not intended to exclude other implementations having additional features, or other implementations incorporating different combinations of the stated features. As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an implementation can or may comprise certain elements or features does not exclude other implementations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an implementation or particular system is included in at least one or more implementations or aspect. The appearances of the phrase “in one aspect” (or variations thereof) are not necessarily referring to the same aspect or implementation. It should also be understood that the various method steps discussed herein do not have to be carried out in the same order as depicted, and not each method step is required in each aspect or implementation.

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions. The term “module,” as used herein, is not intended, under any circumstances, to invoke interpretation of the appended claims under 35 U.S.C. § 112(f).

The terms “a” and “an,” as used herein, are defined as one as or more than one. The term “plurality,” as used herein, is defined as two or more than two. The term “another,” as used herein, is defined as at least a second or more. The terms “including” and/or “having,” as used herein, are defined as including (i.e., open language). The phrase “at least one of … and ….” as used herein refers to and encompasses any and all possible combinations of one or more of the associated listed items. As an example, the phrase “at least one of A, B and C” includes A only, B only, C only, or any combination thereof (e.g., AB, AC, BC or ABC).

The preceding description of the implementations has been provided for purposes of illustration and description. It is not intended to be exhaustive or to limit the disclosure. Individual elements or features of a particular implementation are generally not limited to that particular implementation, but, where applicable, are interchangeable and can be used in a selected implementation, even if not specifically shown or described. The same may also be varied in many ways. Such variations should not be regarded as a departure from the disclosure, and all such modifications are intended to be included within the scope of the disclosure.

While the preceding is directed to implementations of the disclosed devices, systems, and methods, other and further implementations of the disclosed devices, systems, and methods can be devised without departing from the basic scope thereof. The scope thereof is determined by the claims that follow.

What is claimed is:

1. A system, comprising:
a processor; and
a memory storing machine-readable instructions that, when executed by the processor, cause the processor to:
detect, through analysis of input data, a dynamic condition pertaining to one of a vehicle and an environment external to the vehicle; and
display, to an occupant of the vehicle, an animated metaphorical graphical representation of the status, in real time, of the dynamic condition to assist the occupant of the vehicle in engaging with the dynamic condition.

2. The system of claim 1, wherein the input data includes one or more of input from the vehicle occupant, vehicle sensor data, environment sensor data, data from a remote server, physiological data pertaining to the vehicle occupant, vehicle-occupant facial-expression data, vehicle-occupant gaze-tracking data, vehicle-occupant preferences data, and historical driving data pertaining to the vehicle.

3. The system of claim 1, wherein the dynamic condition pertains to an operational state of the vehicle.

4. The system of claim 1, wherein the dynamic condition pertains to at least one of traffic, terrain, weather, and time of day.

5. The system of claim 1, wherein the dynamic condition pertains to a roadway on which the vehicle is traveling.

6. The system of claim 1, wherein the dynamic condition pertains to an external road user.

7. The system of claim 1, wherein the machine-readable instructions to display, to the occupant of the vehicle, the animated metaphorical graphical representation include instructions that, when executed by the processor, cause the processor to display the animated metaphorical graphical representation on at least one of:
one or more displays of an In-Vehicle Information System of the vehicle;
a tablet computer removably mounted to a back side of a seat of the vehicle;
a head-up display (HUD) in the vehicle that is separate from windows of the vehicle;
a HUD that occupies at least a portion of a window of the vehicle;
a rearview mirror of the vehicle; and
a side mirror of the vehicle.

8. The system of claim 1, wherein the machine-readable instructions to display, to the occupant of the vehicle, the animated metaphorical graphical representation include instructions that, when executed by the processor, cause the processor to create the animated metaphorical graphical representation using a generative-artificial-intelligence-based model.

9. A non-transitory computer-readable medium storing instructions that, when executed by a processor, cause the processor to:
detect, through analysis of input data, a dynamic condition pertaining to one of a vehicle and an environment external to the vehicle; and
display, to an occupant of the vehicle, an animated metaphorical graphical representation of the status, in real time, of the dynamic condition to assist the occupant of the vehicle in engaging with the dynamic condition.

10. The non-transitory computer-readable medium of claim 9, wherein the input data includes one or more of input from the vehicle occupant, vehicle sensor data, environment sensor data, data from a remote server, physiological data pertaining to the vehicle occupant, vehicle-occupant facial-expression data, vehicle-occupant gaze-tracking data, vehicle-occupant preferences data, and historical driving data pertaining to the vehicle.

11. The non-transitory computer-readable medium of claim 9, wherein the instructions to display, to the occupant of the vehicle, the animated metaphorical graphical representation include instructions that, when executed by the processor, cause the processor to display the animated metaphorical graphical representation on at least one of:
one or more displays of an In-Vehicle Information System of the vehicle;
a tablet computer removably mounted to a back side of a seat of the vehicle;
a head-up display (HUD) in the vehicle that is separate from windows of the vehicle;
a HUD that occupies at least a portion of a window of the vehicle;
a rearview mirror of the vehicle; and
a side mirror of the vehicle.

12. The non-transitory computer-readable medium of claim 9, wherein the instructions to display, to the occupant of the vehicle, the animated metaphorical graphical representation include instructions that, when executed by the processor, cause the processor to create the animated metaphorical graphical representation using a generative-artificial-intelligence-based model.

13. A method, comprising:
detecting, through automated analysis of input data using a processor, a dynamic condition pertaining to one of a vehicle and an environment external to the vehicle; and
displaying, to an occupant of the vehicle, an animated metaphorical graphical representation of the status, in real time, of the dynamic condition to assist the occupant of the vehicle in engaging with the dynamic condition.

14. The method of claim 13, wherein the input data includes one or more of input from the vehicle occupant, vehicle sensor data, environment sensor data, data from a remote server, physiological data pertaining to the vehicle occupant, vehicle-occupant facial-expression data, vehicle-occupant gaze-tracking data, vehicle-occupant preferences data, and historical driving data pertaining to the vehicle.

15. The method of claim 13, wherein the dynamic condition pertains to an operational state of the vehicle.

16. The method of claim 13, wherein the dynamic condition pertains to at least one of traffic, terrain, weather, and time of day.

17. The method of claim 13, wherein the dynamic condition pertains to a roadway on which the vehicle is traveling.

18. The method of claim 13, wherein the dynamic condition pertains to an external road user.

19. The method of claim 13, wherein the animated metaphorical graphical representation is displayed on at least one of:
one or more displays of an In-Vehicle Information System of the vehicle;
a tablet computer removably mounted to a back side of a seat of the vehicle;
a head-up display (HUD) in the vehicle that is separate from windows of the vehicle;
a HUD that occupies at least a portion of a window of the vehicle;
a rearview mirror of the vehicle; and
a side mirror of the vehicle.

20. The method of claim 13, wherein, prior to being displayed, the animated metaphorical graphical representation is created using a generative-artificial-intelligence-based model.
